(19) United States
(12) Patent Application Publication
(10) Pub. No.: US 2022/0253779 A1
(43) Pub. Date: Aug. 11, 2022

(54) CONSTRUCTION PROJECT MANAGEMENT APPLICATION

(71) Applicant: BUILDERCYCLE CORP., Vancouver (CA)

(72) Inventors: Jackson De Cheng JUE, Vancouver (CA); Brandon STONE, West Vancouver (CA)

(21) Appl. No.: 17/622,749

(22) PCT Filed: Jun. 26, 2020
(86) PCT No.: PCT/CA2020/050898

§ 371 Date: Dec. 24, 2021

Related U.S. Application Data
(60) Provisional application No. 62/868,635, filed on Jun. 28, 2019.

(51) Int. Cl. G06Q 10/06; G06Q 50/08

(52) U.S. Cl. CPC G06Q 10/06316; G06Q 50/08

(57) ABSTRACT

A management system for tracking a progress of a construction project comprises a server, a database, and one or more devices. The database comprises information on a predicted schedule for completion of the tasks on each floor. Each device comprises a graphical user interface to perform the following: accept a first input regarding a current status of one or more of the tasks; display a timeline depicting a range of future dates, wherein the future dates are selectable; and transmit the future dates selected to the server. The server determines a predicted progress for each task in order for the construction project to remain on the predicted schedule. The server further determines an indication as to whether the current status of the tasks is ahead or behind the predicted schedule and causes the graphical user interface to display the indication.

### FIELD OF THE INVENTION

The present invention relates to project management, and in particular, to systems for tracking and monitoring the progress of construction projects.

### BACKGROUND OF THE INVENTION

The construction of high-rise buildings has unique challenges compared to that of single-family houses, commercial buildings, or industrial sites. These challenges include having to manage a large number of tasks that must be completed in a predefined order and in a repetitive manner as the construction progresses from floor to floor. In a high-rise building project, a manager typically contracts with other companies, or contractors, that specialize in performing a particular kind of work (e.g. framing, painting, flooring, etc.) to perform a defined scope of work in a certain period of time for a fixed price.

High-rise buildings are built from the ground up. In other words, construction starts on the lowest floor, where a sequence of tasks must be finished in order to complete that floor. The same sequence of tasks can then be replicated on the next higher floor, and so forth. It is important for managers to determine an optimal sequence of tasks to efficiently complete a project. Each contractor must then follow the sequence in a specific order because subsequent work would build upon the previously completed work. If one contractor tries to progress too far ahead of the next contractor, the work on the floor cannot be completely finished if the previous contractor has not completed all of their work on that floor. As a result, productivity is reduced as a result of having to move the contractor's labor force and tools down to a lower floor, in order to complete the incomplete work on the lower floor.

For example, if the contractor responsible for installing doors does not complete installing a number of doors on a floor, it will negatively impact the subsequent painting contractor because they will be unable to complete painting on that floor and must come back later to paint the missing doors, once they are installed.

In addition, the number of workers working for each contractor is typically fairly constant for each project; the reduced productivity can result in schedule delays, costing the contractors money in increased management overhead and additional labor. If productivity is reduced drastically, this can affect the overall project schedule, leading to delays and increasing the total cost of the project in the form of increased management overhead, financing costs, and penalties for not completing the project on schedule, thereby reducing its profitability on that project and potentially damaging the reputation of the builder.

Another consequence of a contractor's work falling out of sequence is the potential damage to finishes that have already been installed. The sequence is typically organized such that the contractors performing the messiest work with the highest chance of damaging other contractors' work are scheduled to finish their work first. This minimizes the chance of damaging the finishes that are visible. For example, tile setting is typically relatively messy work, involving cement, large pieces of tile, and the sharp edges of cut tiles. If the tile contractor falls so far behind such that the hardwood flooring contractor completes its work first, there is a high possibility that the newly installed hardwood floors will be damaged by the tile contractor working on those floors. Tracking the costs associated with such damage during construction is a time intensive task for the manager. In addition, the manager would have to incur costs associated with fixing the damage caused by contractors, especially if it is not obvious which contractor caused the damage.

The traditional method of tracking construction schedules is by using a Gantt chart. The vertical axis of a Gantt chart represents the various tasks that need to be completed in order to finish a project. The horizontal axis represents the time scale. Each task is represented graphically in the chart using a rectangle whose left and right edges corresponds to the start and end dates of that task. The width of the rectangle corresponds to the duration of that task.

The difficulty with tracking high-rise building projects in this manner is that it is a very cumbersome exercise. If a building has 20 floors, with 30 tasks that must be completed in sequence on each floor, this results in 600 entries in the Gantt chart that must be navigated and updated. This results in a very unwieldy and difficult process for tracking the progress of the construction.

As a related issue, managers typically record progress on paper, and then input this into a spreadsheet for analysis (e.g. to determine which contractors are behind and need to increase production to maintain the schedule). A manager must spend a considerable amount of time both recording the progress on paper and performing data entry.

Therefore, it is desirable for a system to more efficiently track the progress of a construction project and to allow managers determine whether a project is on schedule.

### SUMMARY OF THE INVENTION

In accordance with one embodiment of the present invention, a management system for tracking a progress of a construction project comprising a plurality of floors and a plurality of tasks for each of the floors is provided. The system comprises a server, a database connected to the server, and one or more devices connected to the server. The database comprises information on a predicted schedule for completion of the plurality of tasks on each of the plurality of floors. Each of the devices comprises a graphical user interface that is configured to perform the following: accept a first input regarding a current status of one or more of the plurality of tasks on each of the plurality of floors; display a timeline depicting a range of future dates, wherein one of the future dates is selectable by the user; and transmit the one of the future dates selected by the user to the server. The server is configured to determine, based on the one of the future dates selected by the user and the information on the predicted schedule for completion of the plurality of tasks on each of the plurality of floors, a predicted progress for each of the plurality of tasks on each of the plurality of floors in order for the construction project to remain on the predicted schedule. The server is further configured to determine, based on the current status and the predicted progress, an indication as to whether the current status of the plurality of tasks on each of the plurality of floors is ahead or behind the predicted schedule. The server is further configured to cause the graphical user interface to display the indication.

In another aspect of the invention, the predicted schedule for completion of the plurality of tasks on each of the plurality of floors is configurable by the user.

In yet another embodiment of the invention, the predicted schedule for completion of the plurality of tasks on each of the plurality of floors comprises information on a duration of each of the plurality of tasks.

In a further embodiment of the invention, the predicted schedule for completion of the plurality of tasks on each of the plurality of floors comprises information on a sequence of each of the plurality of tasks on each of the plurality of floors.

In still another aspect of the invention, the server is further configured to cause the graphical user interface to display the predicted progress for each of the plurality of tasks on each of the plurality of floors in a chart.

In still yet another aspect of the invention, the predicted progress for each of the plurality of tasks on each of the plurality of floors is depicted as a stepped line on the chart.

In a further aspect of the invention, the current status of one or more of the plurality of tasks on each of the plurality of floors is inputted to the graphical user interface by the user as a percentage of its completion.

In yet a further aspect of the invention, the current status of one or more of the plurality of tasks on each of the plurality of floors is inputted to the graphical user interface by the user by selecting one of a plurality of predefined percentages of its completion.

In still a further aspect of the invention, one or more of the devices are connected wirelessly to the server.

In yet another aspect of the invention, the range of future dates is broken up into weekly intervals. The range of future dates may also be broken up into daily intervals.

In another aspect of the invention, the indication as to whether the current status of the plurality of tasks on each of the plurality of floors is behind the predicted schedule is based, at least in part, on the current status of each of the plurality of tasks displayed above the stepped line. Furthermore, the indication as to whether the current status of the plurality of tasks on each of the plurality of floors is ahead the predicted schedule is based, at least in part, on the current status of each of the plurality of tasks displayed below the stepped line.

It is an essential feature of the invention to use a computer-implemented system that serves to track the progress of a construction project involving a number of tasks over a number of floors and to provide a determination as to the predicted status of each of the tasks at any time in the future in order for the project to remain on schedule.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The embodiments of the invention will be described by reference to the drawings thereof, in which:

FIG. 1 shows the overall system in accordance with one embodiment of the invention;

FIG. 2 is a screenshot of the graphical user interface showing the project selection screen in accordance with one embodiment of the invention;

FIG. 3 is a screenshot of the graphical user interface showing the tracking mode in accordance with one embodiment of the invention;

FIG. 4 is a screenshot of the graphical user interface showing the tracking mode of FIG. 3 for a different date;

FIG. 5 is a screenshot of the graphical user interface showing the tracking mode of FIG. 3 for still another date;

FIG. 6 is a screenshot of the graphical user interface showing a calendar in accordance with one embodiment of the invention;

FIG. 7 is a screenshot of the graphical user interface showing a high-level Gantt chart in accordance with one embodiment of the invention;

FIG. 8 is a screenshot of the graphical user interface showing a high-level Gantt chart in accordance with one embodiment of the invention;

FIG. 9 is a screenshot of the graphical user interface showing a task sequence editor for the high-level Gantt chart of FIG. 8;

FIG. 10 is a screenshot of the graphical user interface showing an example of the tracking mode for the Gantt chart of FIG. 8, set to weekly forecast for a particular date;

FIG. 11 is a screenshot of the graphical user interface showing an example of the tracking mode for the Gantt chart of FIG. 8, set to weekly forecast for another date;

FIG. 12 is a screenshot of the graphical user interface showing an example of the tracking mode for the Gantt chart of FIG. 8, set to daily forecast for a particular date;

FIG. 13 is a screenshot of the graphical user interface showing an example of the tracking mode for the Gantt chart of FIG. 8, set to daily forecast for another date;

FIG. 14 is a screenshot of the graphical user interface showing another high-level Gantt chart in accordance with one embodiment of the invention;

FIG. 15 is a screenshot of the graphical user interface showing a task sequence editor for the high-level Gantt chart of FIG. 14;

FIG. 16 is a screenshot of the graphical user interface showing an example of the tracking mode for the Gantt chart of FIG. 14, set to weekly forecast for a particular date;

FIG. 17 is a screenshot of the graphical user interface showing an example of the tracking mode for the Gantt chart of FIG. 14, set to weekly forecast for another date;

FIG. 18 is a screenshot of the graphical user interface showing an example of the tracking mode for the Gantt chart of FIG. 14, set to daily forecast for a particular date; and

FIG. 19 is a screenshot of the graphical user interface showing an example of the tracking mode for the Gantt chart of FIG. 14, set to daily forecast for another date.

### DETAILED DESCRIPTION OF THE INVENTION

The present invention may be implemented in numerous ways, including as a process, an apparatus, a system, or a computer program embodied on a computer-readable storage medium. Furthermore, the present invention may also be implemented using a processor, such as through a processor configured to execute instructions stored on and/or provided by a memory coupled to the processor.

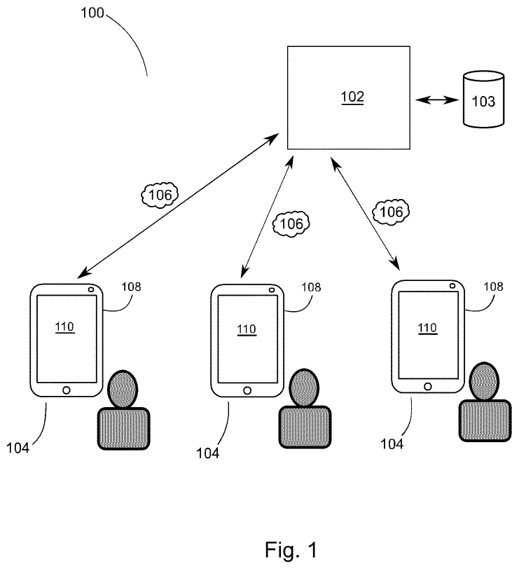

Referring to FIG. 1, a system 100 in accordance with an embodiment of the invention comprises a server 102 and one or more devices 104 connected to the server 102 through a network 106. The network 106 may be the Internet or some other appropriate network. The devices 104 may be generally stationary (e.g. personal computers or workstations) or mobile (e.g. tablets, laptop computers, smartphones, etc.). The devices 104 may be able to communicate with the server 102 through wired or wireless communications (or a combination of both) over the network 106. For example, wireless communications may be done through Bluetooth, Wi-Fi, or cellular communications. Each of the devices 104 comprises a display 108 that is capable of displaying a graphical user interface (GUI) 110 that allows a user to interact with the system 100.

When the user accesses the system 100 through one of the devices 104, the server 102 will provide the GUI 110 for display on the display 108 of the device 104. For example, in one embodiment, the user may access a web browser application on the device 104 that connects with the server 102. The server 102 is configured to generate the GUI 110 for display on the display 108. When the user first initializes the GUI 100, the user may be prompted to input credentials (e.g. username and/or password) to permit access to the server 102.

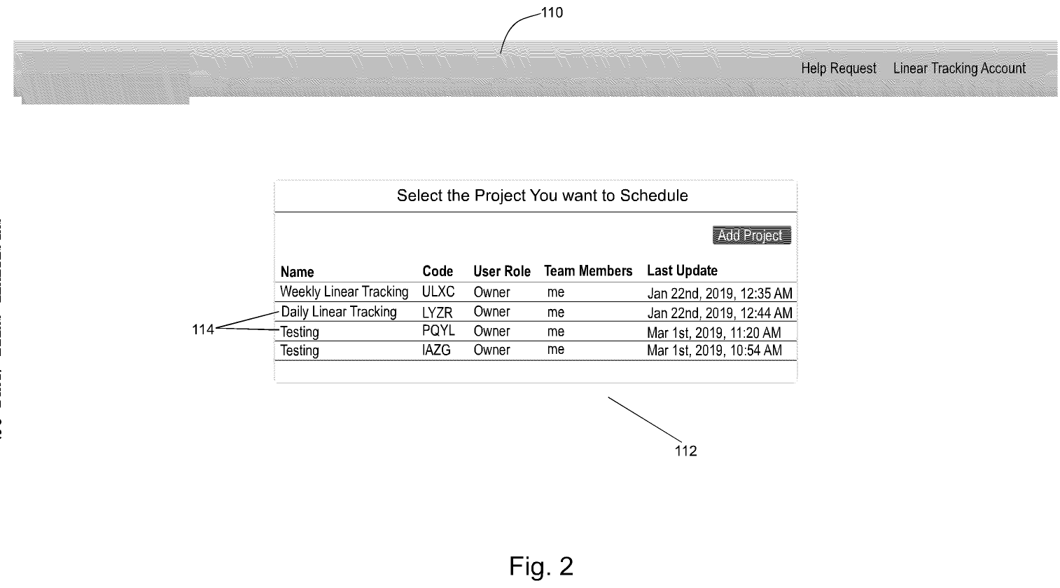

Once the proper credentials have been inputted and verified by the server 102, the server 102 is configured to display on the GUI 110 a project list 112 comprising one or more construction projects 114 being tracked by the system 100, as shown in FIG. 2. In addition, the server 102 is configured to cause the GUI 110 to provide the option for the user to create a new project 114 to be tracked by the system 100.

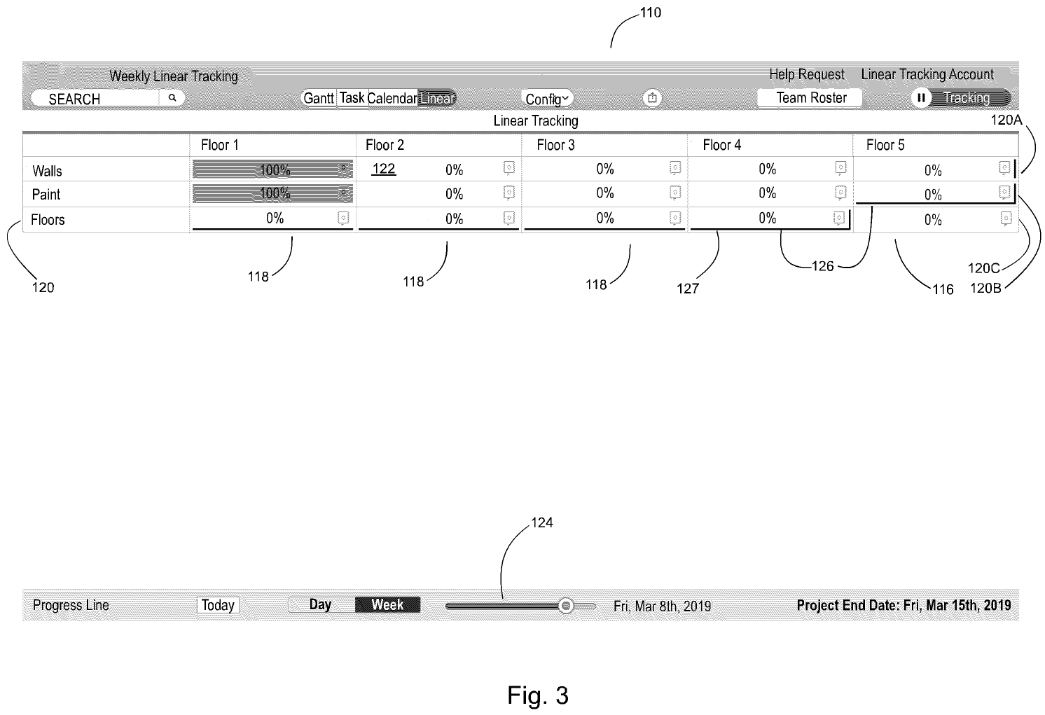

FIG. 3 displays an exemplary screenshot of the GUI 110 for one of the projects 114. The GUI 110 preferably displays a table 116 comprising a number of columns 118 and a number of rows 120. The columns 118 and the rows 120 form a grid of entries 122. Each of the columns 118 preferably corresponds to a floor of the project 114. For example, in the embodiment shown in FIG. 3, there are five columns 118 to represent a five-story building. Each of the rows 120 preferably correspond to a particular task required to be completed for each of the floors. For example, in the embodiment shown in FIG. 3, there are three rows 120 (120A, 120B, 120C), with row 120A corresponding to “Walls”, row 120B corresponding to “Paint”, and row 120C corresponding to “Floors”. This may correspond to the construction of the walls, the painting of the walls, and the construction of the floors, respectively. In other words, the tasks of “Walls”, “Paint”, and “Floors” must be completed for each of the floors in the project 114. It is understood that other and additional tasks may be included in the table 116.

If the user chooses to create the project 114 (i.e. not a pre-existing project 114), the user may be prompted by the GUI 110 to input information such as the number of floors for the project 114 and the tasks for each of the floors. The user may input the information using a variety of mechanisms, such as by touch input, by keyboard input, or a combination of both. Once the user has inputted the information into the GUI 110, the server 102 is configured to cause the GUI 110 to display the table 116 corresponding to the information inputted.

Preferably, the sequence of the tasks to be completed can be specified by and inputted by the user through the GUI 110. For example, the floors are typically worked on sequentially, starting on the lowest floor. In other words, the first floor is first worked on, followed by the second floor, followed by the third floor, and so on. Within each floor, there may be a specific sequence for the tasks to be worked on as well. For example, in the embodiment shown in FIG. 3, the user may specify through the GUI 110 that for each particular floor, the “Walls” must be worked on first, followed by the “Paint” and finally the “Floors”. The user may further specify through the GUI 110 the expected duration of each of the tasks and that a task must be completely finished before a subsequent task may be commenced.

Each of the entries 122 provide an indication of the status of the task for the corresponding column 118 and row 120. For example, in the embodiment shown in FIG. 3, the entry 122 corresponding to the column 118 for “Floor 1” and the row 120 for “Walls” is shown as being 100% completed. Similarly, the entry 122 corresponding to the column 118 for “Floor 1” and the row 120 for “Paint” is also shown as being 100% completed. The remaining entries 122 are shown as being 0% completed. This would indicate that on the first floor, both the “Walls” and the “Paint” tasks have been completed and that the “Floors” task has not yet commenced. None of the tasks for any of the other floors have been commenced.

The user is able to update through the GUI 110 the progress of a particular task on a particular floor by selecting the corresponding entry 122 in the table 116 and entering level of completion of that task. Preferably, the user is able to select, through the GUI 110, from a preset list of percentages (e.g. 0%, 25%, 50%, 75%, 100%) for the particular entry 122. Alternatively, the user may enter a numerical percentage directly through the GUI 110 for the entry 122. In addition, once the level of completion for the particular entry 122 has been inputted, that particular entry 122 may be displayed in different colors, depending on the level of completion of the task corresponding to the particular entry 122. For example, if the particular entry 122 is indicated by the user as being completed (i.e. 100%), it may be displayed with a green color. Similarly, if the particular entry 122 is indicated by the user to be partially completed (e.g. 50%), it may be displayed with a orange color.

The display of the table 116 by the GUI 110 allows the user to quickly and conveniently view the current overall progress of the project 114. The user is able to quickly and conveniently determine which floors have been completed and the outstanding tasks for the uncompleted floors. The table 116 also allows the user to quickly and conveniently update the status of particular tasks for the project 114.

In addition to viewing the current overall progress of the project 114 through the GUI 110, the user is also able to view the overall progress of the project 114 with respect to a predefined schedule.

When the user defines the tasks to be included in the rows 120, the user is also able to specify through the GUI 110 an estimated timeframe for the completion of each of the tasks. In this manner, the server 102 is able to determine an estimated schedule for the completion of all of the tasks (both for the floors and for the project 114 as a whole).

Referring to FIGS. 3 to 5, the server 102 is further configured to cause the GUI 110 to display a timeline 124. The timeline 124 will allow the user to select particular points in time between the start and the estimated completion of the project 114. As different points in the timeline 124 are selected by the user, the GUI 110 will display an indicator 126 about certain of the entries 122. For example, different points on the timeline 124 may be selected by the user by the user touching the GUI 110 on particular places on the timeline 124.

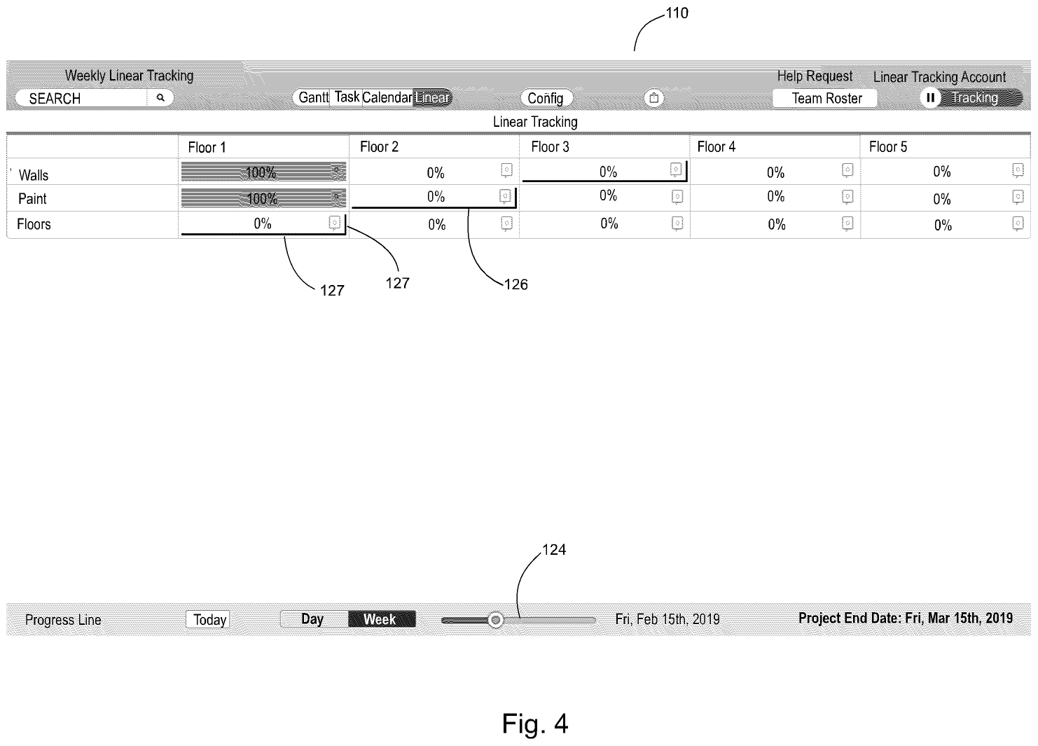

In the embodiment shown in FIGS. 3 to 5, the indicator 126 will delineate the tasks that should already have been completed in order for the project 114 to remain on schedule. This determination is made by the server 102 based, at least in part, on the number of floors, the number of tasks, the duration of each of the tasks, and the sequence of the tasks. The entries 122 corresponding to tasks that should already have been completed will appear above the indicator 126. For example, in the embodiment shown in FIG. 4, when Feb. 15, 2019 is selected on the timeline 123, the indicator 126 delineates all of the tasks for Floor 1 should have been completed, the “Walls” and “Paint” tasks for Floor 2 should have been completed, and the “Walls’ task for Floor 3 should have been completed, if the project 114 is to remain on schedule. As different points on the timeline 124 are selected, the indicator 126 will change accordingly.

In the embodiment shown in FIGS. 3 to 5, the indicator 126 comprises one or more edges 127 that run along the sides of one or more of the entries 122. For example, the indicator 126 may take the form of a stepped line that runs across the table 116.

For example, if the user selects today's date on the timeline 124, the server 102 will cause the GUI 110 to display on the table 116 the indicator 126 to indicate the tasks that should have been completed to date in order for the project 114 to remain on schedule. This provides the user with an indication of the current status of the project 114. If all of the entries 122 above the indicator 126 are already indicated to be completed, then the project 114 is still on schedule, as all of the necessary tasks have already been completed. However, if some of the entries 122 above the indicator 126 are still indicated as being incomplete, then the project 114 is behind schedule, and the user can take corrective measures to address this.

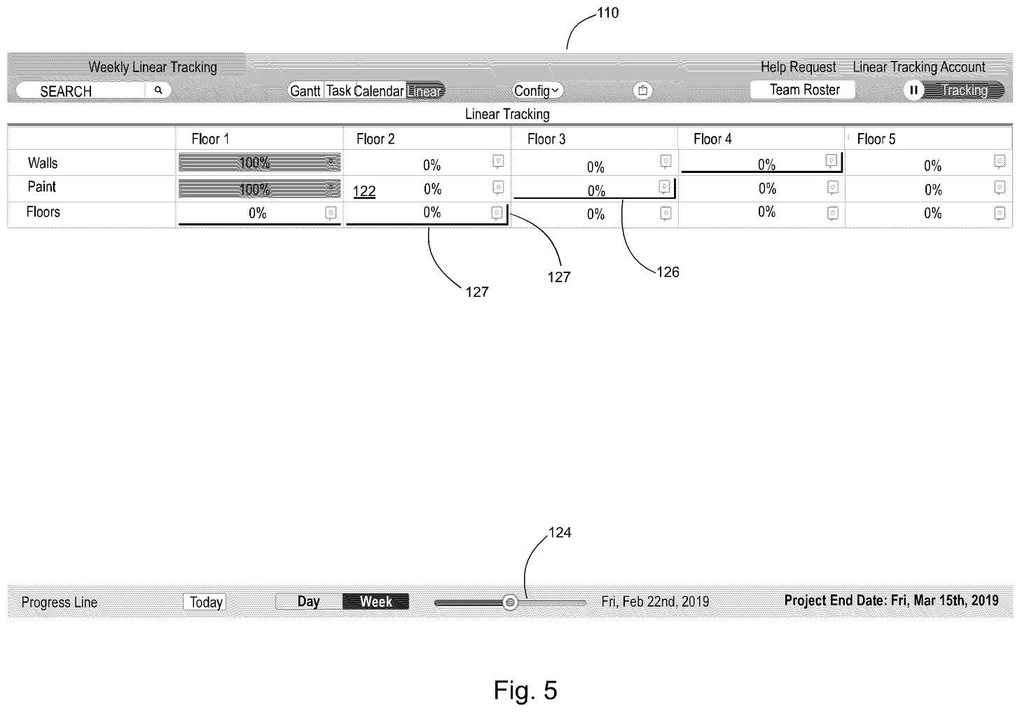

Similarly, if the user selects a future date on the timeline 124 (e.g. a date one week from Feb. 15, 2019, as shown in FIG. 5), the server 102 will cause the GUI 110 to display on the table 116 the indicator 126 to indicate the tasks that should be completed by that future date in order for the project 114 to remain on schedule. The user can determine the entries 122 above the indicator 126 that correspond to tasks that still remain to be completed. Based on this information, the user can determine whether it would be likely that those tasks will be completed by the future date and take corrective measures as necessary (e.g. bring in more manpower, etc.).

Although the embodiment shown in FIGS. 3 to 5 depict the indicator 126 as comprising edges 127 forming a stepped line, it is understood that instead of depicting a stepped line, other forms of displaying the indicator 126 may be used. For example, different colors may be used to show the tasks that should be completed by a particular date (compared to tasks that do not need to be completed). Other methods of delineating the difference between tasks that should be completed and tasks that do not yet have to be completed may be used.

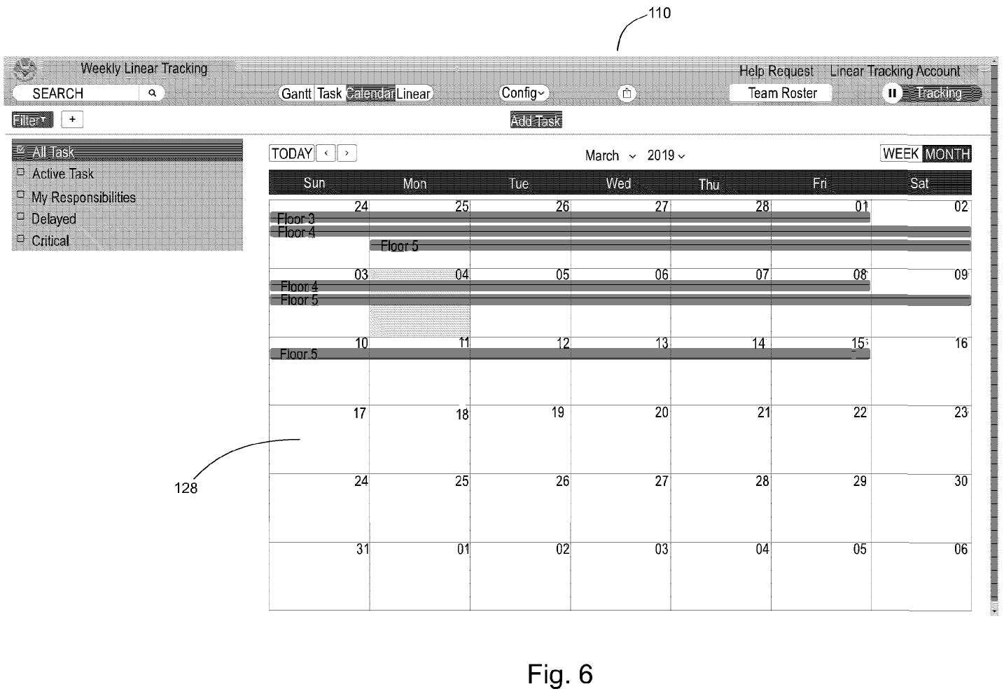

In addition to the GUI 110 displaying the table 116, the server 102 can also be configured to cause the GUI 110 to display other information relating to the project 114. Referring to FIG. 6, the GUI 110 can be configured to display a calendar 128 in order to show the timeframes for completion of the various floors.

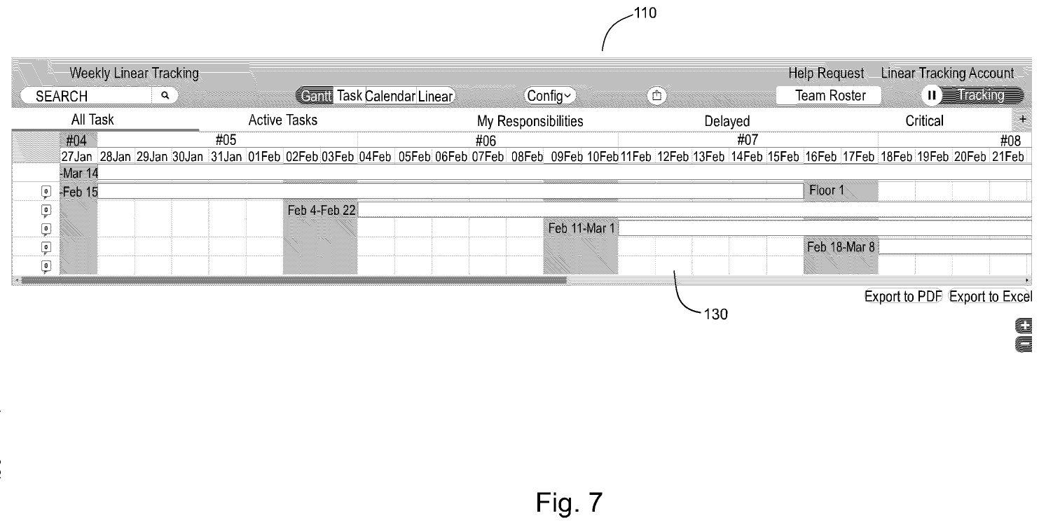

Referring to FIG. 7, the server 102 can also be configured to cause the GUI 110 to display a Gantt chart in order to show the progress of the project 114.

Using the GUI 110, the user is able to switch among the different views of the progress of the project 114.

FIGS. 8 to 13 show another example of the tracking and forecasting features of the present invention. In this embodiment, the project 114 is made up of a number of floors. For example, FIG. 8 shows that the project 114 has five floors, although other numbers of floors are of course also possible. The user is able to input through the GUI 110 to set the start dates for each of the floors. In the embodiment shown in FIG. 8, the respective start dates for each of the floors are set for 5 working days apart from each other (e.g. April 4, April 11, April 18, April 26, May 2).

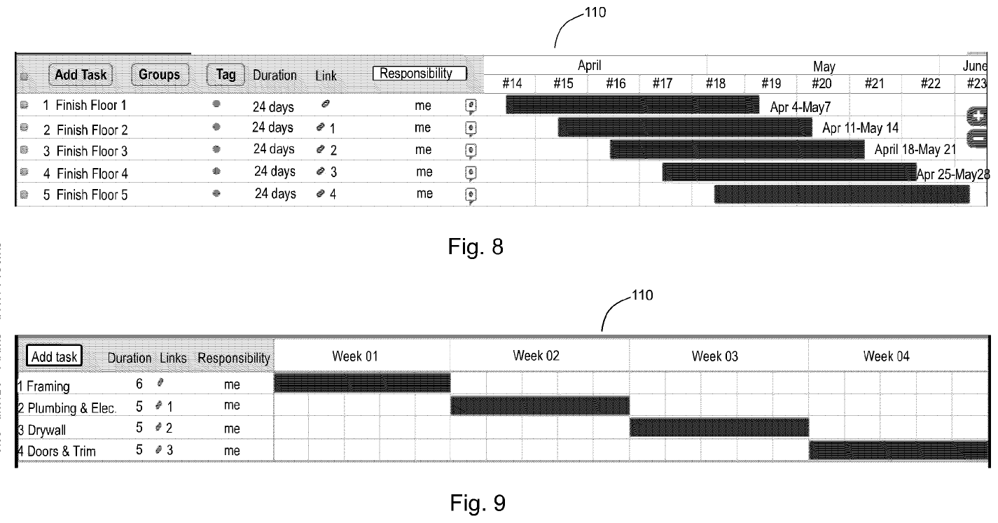

Referring to FIG. 9, each of the floors requires the completion of a number of tasks (by way of example only, they are shown in FIG. 9 as “framing”, “plumbing/electrical”, “drywall”, and “doors/trim”). In order to complete a floor, each of the tasks for that particular floor must be completed in sequence (i.e. framing must be completed before commencing plumbing/electrical, which must be completed before commencing drywall, etc.).

Referring to FIG. 9, the user is able to input through the GUI 110 to define the tasks, their durations, and their sequence of completion. In the embodiment shown in FIG. 9, all of the tasks are all given the same duration (e.g. 5 days). It is understood that it is also possible to define different durations for different ones of the tasks.

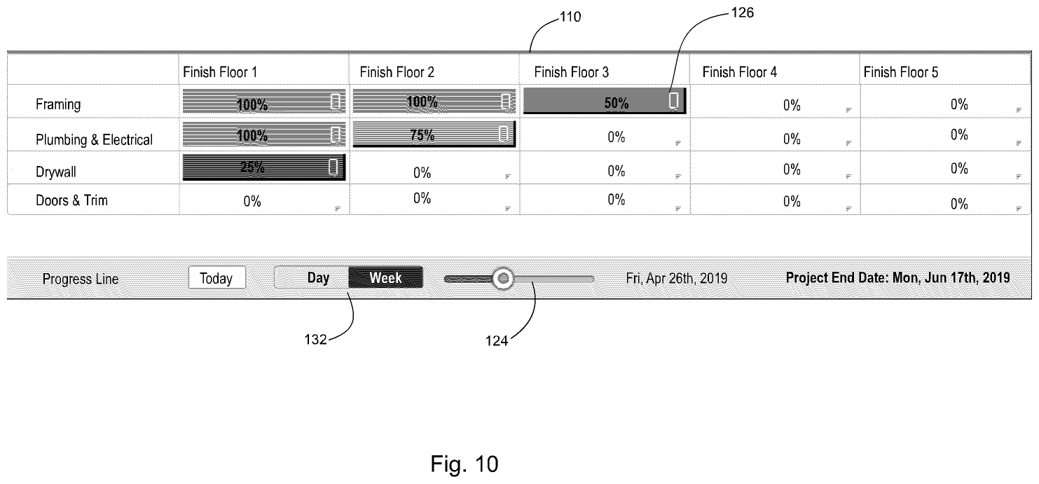

FIGS. 10 to 13 show the GUI 110 depicting different tracking modes for the project 114 depending on the options selected by the user. For example, FIG. 10 shows the tracking of the project 114 based on a weekly forecast mode for a particular point in time. The user may be able to select between a weekly forecast mode and a daily forecast mode by selecting a time mode button 132 on the GUI 110. In the example shown in FIG. 10, since the time mode button 132 is set to “week” mode, the particular week may then be selected by the user using the timeline 124. Furthermore, the user is able to enter into the GUI 110 the progress of various of the tasks on each of the floors. For example, FIG. 10 shows that the framing task have been indicated as being 100% completed on the first and second floors and 50% completed on the third floor. Similarly, the plumbing/electrical task has been indicated as being completed on the first floor and 75% completed on the second floor. Finally, the drywall task has been indicated as being 25% completed on the first floor. All of the other tasks have been indicated as being not yet commenced (i.e. 0%).

Referring again to FIG. 10, the server 102 is configured to cause the GUI 110 to display the indicator 126, which indicates the tasks that need to be completed in order to keep the project 114 on schedule. The server 102 determines the location of the indicator 126 based, at least in part, on the number of floors in the project 114, the number of tasks for each of the floors, the duration of the tasks for each of the floor, and the sequence of the tasks for each of the floors. For example, in the example shown in FIG. 10, the GUI 110 indicates that by the week ending April 26, the tasks above the indicator 126 should be indicated as being completed in order for the project 114 to remain on schedule.

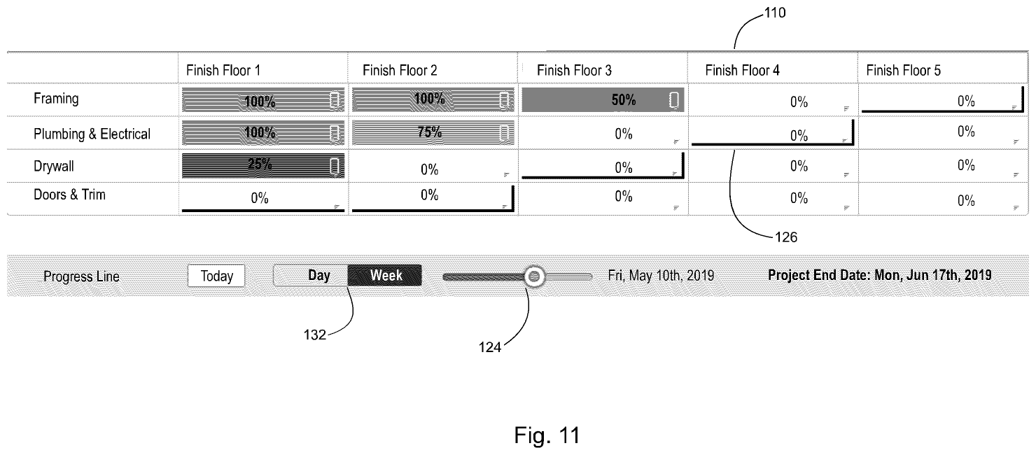

Referring to FIG. 11, in this example, the user has selected another week using the timeline 124 (e.g. the week ending May 10). The server 102 is now configured to cause the GUI 110 to display the indicator 126 to be further to the right and lower than in FIG. 10, as the week selected is later than before. The indicator 126 again shows the tasks that must be completed in order for the project 114 to remain on schedule. In other words, the tasks shown above the indicator 126 should be indicated as being completed by May 10 in order for the project 114 to remain on schedule.

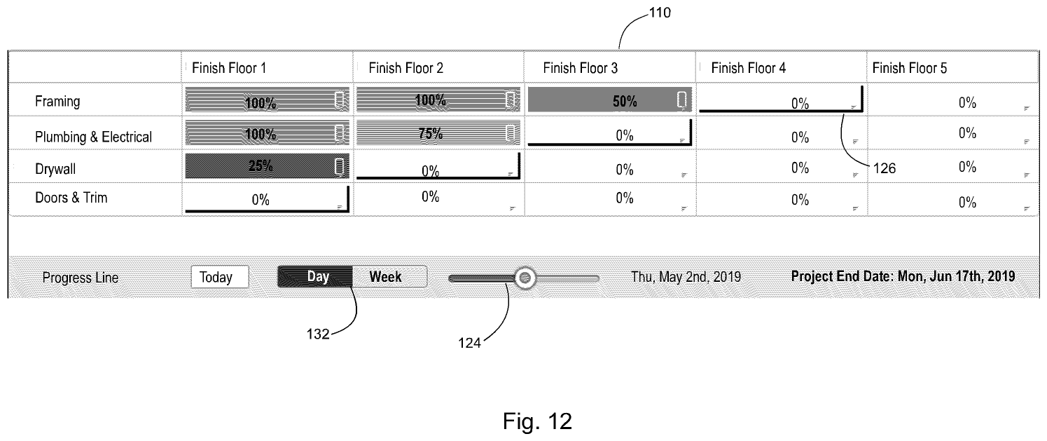

FIG. 12 shows the GUI 110 when the user selects “day” mode using the time mode button 132. When this is selected, the server 102 will cause the GUI 110 to display the progress and the forecasted progress for a particular day. The user can then select a particular day (e.g. May 2) using the timeline 124. This results in the server 102 causing the GUI 110 to display the indicator 126, which indicates the tasks that must be completed by that date in order for the project 114 to remain on schedule.

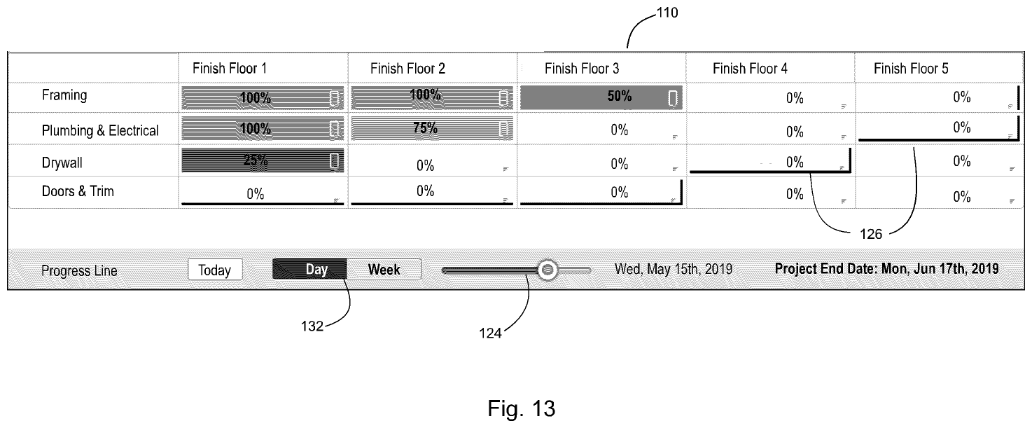

FIG. 13 shows the GUI 110 when the user selects a different date (e.g. May 15) using the timeline 124. As the date selected in FIG. 13 is further away in the future than the date selected in FIG. 12, the indicator 126 is further to the right and lower than in FIG. 12.

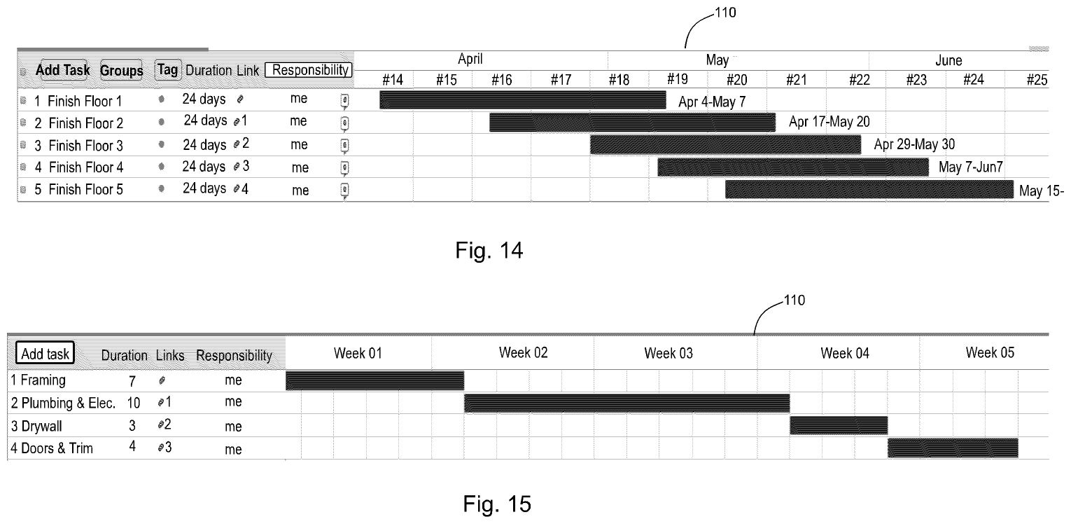

FIGS. 14 and 15 show a Gantt chart for a more complex project 114. In this embodiment, the project 114 again has a number of floors (e.g. five floors), with each floor having a number of tasks (e.g. framing, plumbing/electrical, drywall, doors/trim) that must be completed in sequence. However, in this case, the floors may be started at varying intervals (e.g. 9 working days, 8 working days, 6 working days, 7 working days). In addition, as shown in FIG. 15, the tasks may also have differing durations.

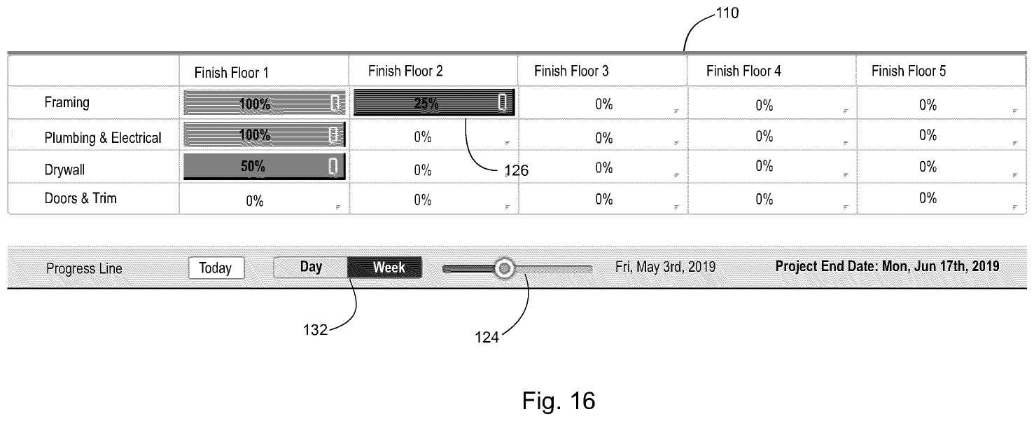

FIGS. 16 to 19 show the GUI 110 depicting different tracking modes for the project 114 shown in FIGS. 14 and 15, depending on the options selected by the user. For example, FIG. 16 shows the tracking of the project 114 based on a weekly forecast mode for a particular point in time. In the example shown in FIG. 16, since the time mode button 132 is set to “week” mode, the particular week may then be selected by the user using the timeline 124. The user is able to enter into the GUI 110 the progress of various of the tasks on each of the floors. For example, FIG. 16 shows that the framing task have been indicated as being 100% completed on the first floor and 25% completed on the second floor. Similarly, the plumbing/electrical task has been indicated as being 100% completed on the first floor. Finally, the drywall task has been indicated as being 100% completed on the first floor. All of the other tasks have been indicated as being not yet commenced (i.e. 0%).

Referring again to FIG. 16, the server 102 is configured to cause the GUI 110 to display the indicator 126, which indicates the tasks that need to be completed in order to keep the project 114 on schedule. For example, in the example shown in FIG. 10, the GUI 110 indicates that by the week ending May 3, the tasks above the indicator 126 should be completed in order for the project 114 to remain on schedule.

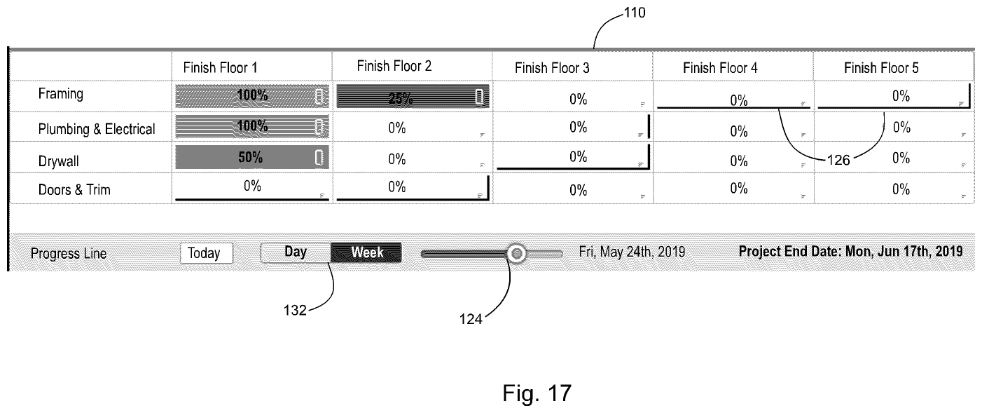

Referring to FIG. 17, in this example, the user has selected another week using the timeline 124 (e.g. the week ending May 24). The server 102 is configured to cause the GUI 110 to display the indicator 126 to be further to the right and lower than in FIG. 16, as the week selected is later than before. The indicator 126 again displays the tasks that must be completed in order for the project 114 to remain on schedule. Because in this embodiment, the floors are started at varying intervals and the tasks have varying durations, the indicator 126 may not necessarily have the same consistently staggered look as in FIGS. 10 to 13. The server 102 determines the location of the indicator 126 based, at least in part, on the number of floors in the project 114, the number of tasks for each of the floors, the duration of the tasks for each of the floor, and the sequence of the tasks for each of the floors.

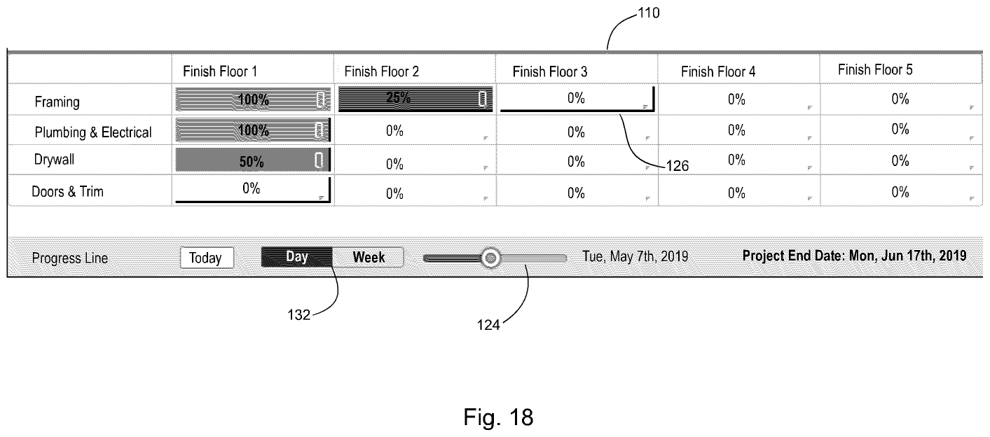

FIG. 18 shows the GUI 110 when the user selects “day” mode using the time mode button 132. This mode will result in the server 102 causing the GUI 110 to display the progress and the forecasted progress for a particular day. The user can then select a particular day (e.g. May 7) using the timeline 124. The GUI 110 again displays the indicator 126, which indicates the tasks that must be completed by that date in order for the project 114 to remain on schedule.

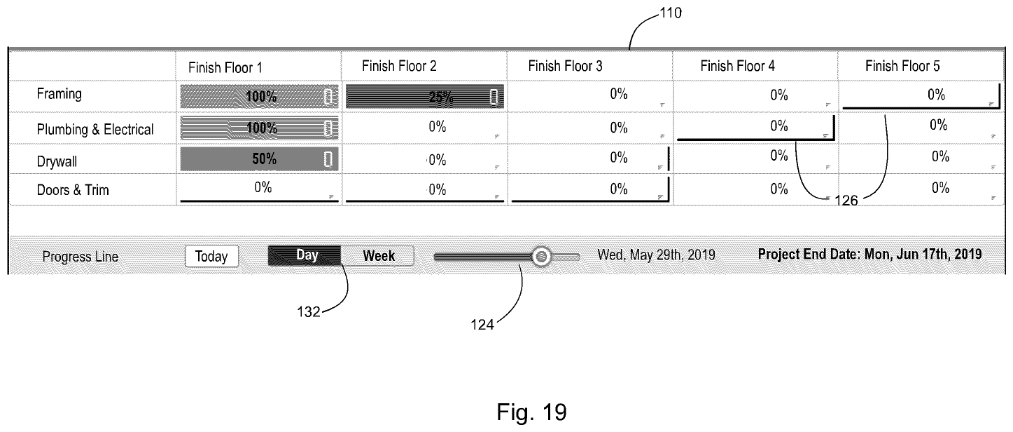

FIG. 19 shows the GUI 110 when the user selects a different date (e.g. May 29) using the timeline 124. As the date selected in FIG. 19 is further away in the future than the date selected in FIG. 18, the indicator 126 is further to the right and lower than in FIG. 18.

In another embodiment, the user is able to input through the GUI 110 that certain of the tasks for the project 114 will be delayed. For example, the user may indicate through the GUI 110 that certain of the tasks are unavoidably delayed, and the delay will not be able to be made up. In these circumstances, the server 102 is configured to reset the schedule for the project 114 and redetermine the location of the indicator 126, based on the new information. The server 102 may cause the GUI 110 to display the new location of the indicator 126 so that the user is able to view the new schedule for the project 114. Subsequently, when the user interacts with the GUI 110 to update the progress of the various tasks for the project 114, the server 102 will cause the GUI 110 to display the overall progress based on the new schedule. In this manner, the system 100 is able to dynamically adjust the schedule for the project 114 based on updated information regarding the completion of the tasks.

Referring back to FIG. 1, because the information regarding the project 114 is managed by and stored on the server 102, different ones of the devices 104 may communicate with the server 102 and access the same project 114. For example, a first user with a first one of the devices 104 may update and view the status of the construction of the project 114 while a second user with a second one of the devices 104 may also update and view the status of the construction of the project 114 at the same time. By employing the system architecture shown in FIG. 1, the system 100 is able to update and track, in real time, the progress of the project 114 across a plurality of devices 104.

In another embodiment, referring to FIG. 1, the server 102 may be connected to a database 103. The database 103 may be used to store information regarding one or more of the projects 114. This information may include information such as the number of floors, the tasks for each floor, the expected duration of each of the tasks, the sequencing of the tasks, and the completion status for each of the tasks. In this manner, when the user accesses the server 102 through the GUI 110 on the device 104, the user can select one of the projects 114 stored on the database 103. The server 102 can then access the appropriate one of the projects 114 and allow the user to update or view the status of the project 114 through the GUI 110, as described above.

It will be appreciated by those skilled in the art that the preferred embodiment has been described in some detail but that certain modifications may be practiced without departing from the principles of the invention.

1. A management system for tracking a progress of a construction project comprising a plurality of floors and a plurality of tasks for each of the floors, the system comprising:
a server;
a database connected to the server, the database comprising information on a predicted schedule for completion of the plurality of tasks on each of the plurality of floors;
one or more devices connected to the server, wherein each of the devices comprises a graphical user interface that is configured to:
accept a first input regarding a current status of one or more of the plurality of tasks on each of the plurality of floors;
display a timeline depicting a range of future dates, wherein one of the future dates is selectable by the user; and
transmit the one of the future dates selected by the user to the server;
wherein, the server is configured to determine, based on the one of the future dates selected by the user and the information on the predicted schedule for completion of the plurality of tasks on each of the plurality of floors, a predicted progress for each of the plurality of tasks on each of the plurality of floors in order for the construction project to remain on the predicted schedule; and
wherein the server is further configured to determine, based on the current status and the predicted progress, an indication as to whether the current status of the plurality of tasks on each of the plurality of floors is ahead or behind the predicted schedule; and
wherein the server is further configured to cause the graphical user interface to display the indication.

2. The management system of claim 1, wherein the predicted schedule for completion of the plurality of tasks on each of the plurality of floors is configurable by the user.

3. The management system of claim 2, wherein the predicted schedule for completion of the plurality of tasks on each of the plurality of floors comprises information on a duration of each of the plurality of tasks.

4. The management system of claim 3, wherein the predicted schedule for completion of the plurality of tasks on each of the plurality of floors comprises information on a sequence of each of the plurality of tasks on each of the plurality of floors.

5. The management system of claim 1, wherein the server is further configured to cause the graphical user interface to display the predicted progress for each of the plurality of tasks on each of the plurality of floors in a chart.

6. The management system of claim 5, wherein the predicted progress for each of the plurality of tasks on each of the plurality of floors is depicted as a stepped line on the chart.

7. The management system of claim 1, wherein the current status of one or more of the plurality of tasks on each of the plurality of floors is inputted to the graphical user interface by the user as a percentage of its completion.

8. The management system of claim 1, wherein the current status of one or more of the plurality of tasks on each of the plurality of floors is inputted to the graphical user interface by the user by selecting one of a plurality of predefined percentages of its completion.

9. The management system of claim 1, wherein one or more of the devices are connected wirelessly to the server.

10. The management system of claim 1, wherein the range of future dates is broken up into weekly intervals.

11. The management system of claim 1, wherein the range of future dates is broken up into daily intervals.

12. The management system of claim 7, wherein the indication as to whether the current status of the plurality of tasks on each of the plurality of floors is behind the predicted schedule is determined, at least in part, by the current status of each of the plurality of tasks displayed above the stepped line.

13. The management system of claim 7, wherein the indication as to whether the current status of the plurality of tasks on each of the plurality of floors is ahead the predicted schedule is based, at least in part, on the current status of each of the plurality of tasks displayed below the stepped line.
